(19) United States
(12) Patent Application Publication
(10) Pub. No.: US 2003/0223131 A1
(43) Pub. Date: Dec. 4, 2003

(54) Optical subassembly (OSA) having a multifunctional acrylate resin adhesive for optoelectronic modules, and method of making same

(75) Inventor: Joseph Paul Kuczynski, Rochester, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY

(21) Appl. No.: 10/161,280

(22) Filed: May 31, 2002

(51) Int. Cl. G02B 7/02

(52) U.S. Cl. 359/819

(57) ABSTRACT

An optical subassembly for an optoelectronic module includes a multifunctional acrylate resin adhesive to adhere a lens and/or an optoelectronic device, e.g., having a laser or a photoelectric receiver chip. An adhesive composition including a multifunctional acrylate resin cures to form an adhesive having a tightly cross-linked network of low CTE (coefficient of thermal expansion). The adhesive's low CTE can improve (as compared to conventional, optically clear adhesives) the vertical offset, for example, of the lens relative to the optoelectronic device at the operating temperature of the subassembly. For example, an adhesive composition including a multifunctional acrylate resin (e.g., a di-, tri-, tetra-, pentafunctional acrylate resin, or a mixture thereof) may be applied to a ball lens and/or a recess of a silicon optical bench, which are then joined and the adhesive composition cured. The adhesive composition may be cured by exposure to UV radiation and/or heat, for example.

### CROSS-REFERENCE TO RELATED APPLICATION

This patent application is related to copending application Ser. No. 09/915,884 (docket no. ROC920010031 US 1), filed Jul. 26, 2001, entitled “OPTICAL SUBASSEMBLY (OSA) FOR OPTOELECTRONIC MODULES, AND METHOD OF MAKING SAME”, which is assigned to the assignee of the instant application.

### FIELD OF THE INVENTION

The present invention relates in general to optoelectronic modules. More particularly, the present invention relates to an optical subassembly (OSA) having a multifunctional acrylate resin adhesive, and a method of making the same.

### BACKGROUND

The development of the EDVAC computer system of 1948 is often cited as the beginning of the computer era. Since that time, computer systems have evolved into extremely sophisticated devices, and computer systems may be found in many different environments. Since the dawn of the computer age, cables have been used to transfer data between computers and input/output devices, and between computers. For example, cables are used in input/output (I/O) device attachment applications, such as disk drive, tape storage and printer attachment. Cables are also used in networking applications, such as local-area networks (LANs) and wide-area networks (WANs). An important trend in the past ten years has been the increasing use of fiber optic cables in such applications.

Fiber optic cables typically include a connector at each end that is plugged into a receptacle associated with the computer or I/O device. Typically the receptacle is part of an optoelectronic module that is electrically connected to the computer or I/O device. For example, the optoelectronic module may be connected to an electronic circuit board of the computer or I/O device using a fixed connection, e.g., a pin-through-hole arrangement, or a removable connection, e.g., a hot-pluggable contact pad mechanism. The optoelectronic module may receive optical signals from a fiber optic cable plugged into its receptacle and/or may transmit optical signals to a fiber optic cable plugged into the receptacle. An optoelectronic module that both transmits and receives optical signals is often referred to as an optoelectronic transceiver module.

An optoelectronic transceiver module typically receives optical signals from the fiber optic cable, converts the optical signals to electrical signals, and provides the electrical signals to the electronic circuit board of the computer or I/O device. Likewise, an optoelectronic transceiver module typically receives electrical signals from the electronic circuit board of the computer or I/O device, converts the electrical signals to optical signals, and provides the optical signals to the fiber optic cable. The optoelectronic transceiver module typically receives optical signals from the fiber optic cable using a receiver optical subassembly (ROSA) and provides the optical signals to the fiber optic cable using a transmitter optical subassembly (TOSA).

A ROSA typically includes a lens that receives the optical signals from the fiber optic cable and focuses the optical signals on an optoelectronic device provided with a receiver unit, e.g., a photoelectric receiver chip, that converts the fiber optic signals to electrical signals. Similarly, a TOSA typically includes an optoelectronic device provided with a transmitter unit, e.g., an edge-emitting laser (CD) or a surface-emitting laser (VCSEL), that converts electrical signals to optical signals that are directed onto a lens that directs the optical signals to the fiber optic cable.

Adhesives presently utilized for alignment of optical components (e.g., a lens, a laser and/or a photoelectric receiver chip) suffer from high coefficients of thermal expansion (CTE) and/or inadequate clarity. Alignment of optical components is typically accomplished at room temperature regardless of the continuous use temperature of the optical assembly. Because the CTE of optically clear adhesives often exceeds 100 ppm/° C., coupled with the fact that the optical assembly may operate at temperatures approaching 70° C., the adhesive will often expand significantly at operating temperature (as compared to its size when aligned at room temperature). This expansion can result in misalignment of the optical components (e.g., the lens relative to either the laser or the photoelectric receiver chip). In addition, this expansion can result in stress at the bond line (e.g., at an adhesive interface interposed between the lens and either the laser or the photoelectric receiver chip).

Unfilled adhesives, which provide the necessary clarity, typically possess CTE values well in excess of the maximum that can be tolerated to maintain alignment. For example, Norland NOA61 (available from Norland Products Inc., Cranbury, N.J.), possesses a CTE of 220 ppm/° C. at a typical operating temperature of an optical assembly. In addition to causing thermally-induced stress at the bond line, such a high CTE can result in approximately 2 microns of vertical offset at the operating temperature of 70° C., while often less than 0.5 micron of vertical offset can be tolerated. Clearly such high CTE adhesives are not acceptable.

One common method of providing adequate CTE control is to load adhesives with an inorganic filler. The most commonly employed fillers are fused silica and quartz. Commercially available adhesives rely on an inorganic filler to achieve low CTE. An illustrative commercially available mineral filled adhesive is Optocast 3408 (available from Electronic Materials Inc., Breckenridge, Colo.) which has a CTE of 40.6 ppm/° C. at a typical operating temperature of an optical assembly. Unfortunately, the use of inorganic fillers results in opaque adhesives. For numerous precision alignment applications (e.g., when aligning a ball lens relative to an optical bench), the adhesive must be transparent in order to ensure proper dispense volume. Also, for applications where the adhesive serves as an interface between the lens and either the laser or the photoelectric receiver chip, the adhesive must be transparent to ensure proper light transmission. In such applications, inorganic fillers render the adhesive unacceptable. In addition, the use of inorganic fillers can adversely result in high viscosity and reduced photospeed (i.e., a measure of the rate at which a photocurable adhesive cures).

Therefore, there exists a need to provide an enhanced optical subassembly (OSA), and a method of making the same.

### SUMMARY OF THE INVENTION

An object of the present invention is to provide an enhanced optical subassembly (OSA), and method of making the same, that addresses these and other problems associated with the prior art.

These and other objects of the present invention are achieved by providing an enhanced optical subassembly, and a method of making the same, that includes a multifunctional acrylate resin adhesive to adhere a lens and/or an optoelectronic device, e.g., having a laser or a photoelectric receiver chip. An adhesive composition including a multifunctional acrylate resin cures to form an adhesive having a tightly cross-linked network of low CTE (coefficient of thermal expansion). The adhesive's low CTE can improve (as compared to conventional, optically clear adhesives) the vertical offset, for example, of the lens relative to the optoelectronic device at the operating temperature of the subassembly. For example, an adhesive composition including a multifunctional acrylate resin (e.g., a di-, tri-, tetra-, pentafunctional acrylate resin, or a mixture thereof) may be applied to a ball lens and/or a recess of a silicon optical bench, which are then joined and the adhesive composition cured. The adhesive composition may be cured by exposure to UV radiation and/or heat, for example.

### BRIEF DESCRIPTION OF THE DRAWINGS

The present invention together with the above and other objects and advantages can best be understood from the following detailed description of the embodiments of the invention illustrated in the drawings, wherein like reference numerals denote like elements.

FIG. 1 is a block diagram of a networked computer system consistent with the present invention.

FIG. 2 is an exploded perspective view of an optoelectronic transceiver module having a pair of optical subassemblies (OSAs) consistent with the present invention.

FIG. 3 is an exploded perspective enlarged view of one of the optical subassemblies (OSAs) of the optoelectronic transceiver module shown in FIG. 2. The OSA is shown in FIG. 3 prior to application of a multifunctional acrylate resin adhesive interface according to an embodiment of the present invention shown in FIG. 4.

FIG. 4 is a cross-sectional view of an optical subassembly (OSA) that includes a multifunctional acrylate resin adhesive interface according to an embodiment of the present invention.

FIG. 5 is a side elevational view of an optical subassembly (OSA) that includes multifunctional acrylate resin adhesive contact points according to another embodiment of the present invention.

### DETAILED DESCRIPTION OF THE PREFERRED EMBODIMENTS

### Hardware Environment

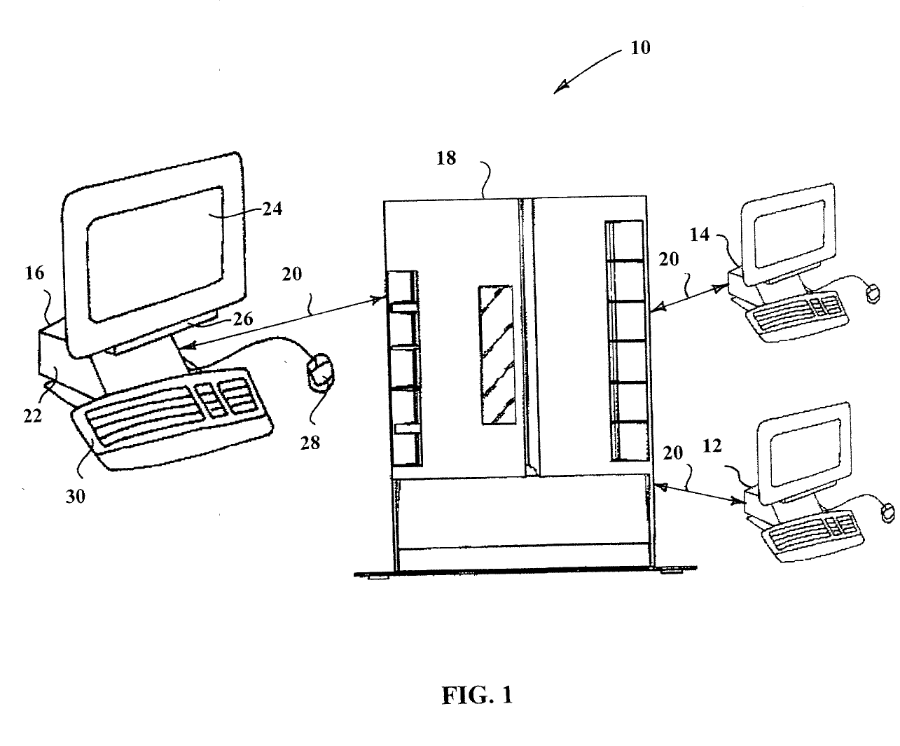

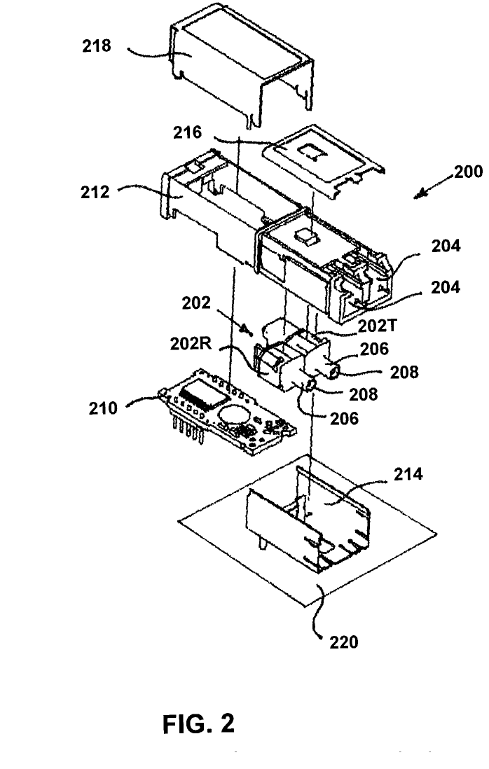

FIG. 1 illustrates a computer system 10 that is consistent with the invention. Computer system 10 is illustrated as a networked computer system. Computer system 10 includes one or more client computers 12, 14 and 16 (e.g., desktop or PC-based computers, workstations, etc.) coupled to server computer 18 (e.g., a PC-based server, a minicomputer, a midrange computer, a mainframe computer, etc.) through a network 20. The server computer 18 may comprise a plurality of enclosures as an alternative to the single enclosure illustrated in FIG. 1. Network 20 may represent practically any type of networked interconnection. For example, network 20 may be a local-area network (LAN), a wide-area network (WAN), a wireless network, and a public network (e.g., the Internet). Moreover, any number of computers and other devices may be networked through the network 20, e.g., multiple servers. In one application of the present invention, server computer 18 and one or more of client computers 12, 14 and 16 may each include an optoelectronic module (shown in FIG. 2) having an optical subassembly provided with a multifunctional acrylate resin adhesive according to the present invention and a receptacle into which may be plugged an optic fiber cable to form network 20 or a portion thereof. For example, the optoelectronic module may be connected to an electronic circuit board of a networking adapter of the computer using a conventional fixed connection, e.g., a pin-through-hole arrangement, or a conventional removable connection, e.g., a hot-pluggable contact pad mechanism.

Client computer 16, which may be similar to client computers 12 and 14, may include a central processing unit (CPU) 22; a number of peripheral components such as a computer display 24; a storage device 26; and various input devices (e.g., a mouse 28 and a keyboard 30), among others. Server computer 18 may be similarly configured, albeit typically with greater processing performance and storage capacity, as is well known in the art. In another application of the present invention, input/output devices (e.g., disk drives, tape drives and printers) and client computer 16 (or server computer 18) may each include an optoelectronic module (shown in FIG. 2) having an optical subassembly provided with a multifunctional acrylate resin adhesive according to the present invention and a receptacle into which may be plugged an optic fiber cable that forms an interconnection (or a portion thereof) between the input/output devices and client computer 16 (or server computer 18). For example, the optoelectronic module may be connected to an electronic circuit board of an I/O adapter of the computer using a conventional fixed connection, e.g., a pin-through-hole arrangement, or a conventional removable connection, e.g., a hot-pluggable contact pad mechanism.

In yet another application of the present invention, various other electronic components of client computer 16 (or server computer 18) may each include an optoelectronic module (shown in FIG. 2) having an optical subassembly provided with a multifunctional acrylate resin adhesive according to the present invention and a receptacle into which may be plugged an optic fiber cable that forms an interconnection (or a portion thereof) between the electronic components within a single computer enclosure and/or between a plurality of enclosures of the computer. For example, the optoelectronic module may be connected to an electronic circuit board of each of such electronic components of the computer using a conventional fixed connection, e.g., a pin-through-hole arrangement, or a conventional removable connection, e.g., a hot-pluggable contact pad mechanism.

Although shown and described above in the environment of a computer, the present invention is not limited thereto. In general, the optical subassembly of the present invention may be used in any electrical devices or components that utilize a fiber optic cable interconnection, for example.

FIG. 2 is an exploded perspective view of an optoelectronic transceiver module 200 having a pair of optical subassemblies (OSAs) 202 consistent with the present invention. The pair of OSAs includes a receiver optical subassembly (ROSA) 202R and a transmitter optical subassembly (TOSA) 202T. It should be appreciated, however, that the present invention is not limited to the use of a pair of OSAs. Any number of OSAs may be used. Moreover, the present invention is not limited to use in the context of an optical transceiver module. For example, the present invention may be employed with respect to an optoelectronic receiver module or a optoelectronic transmitter module.

Optoelectronic transceiver module 200 includes a pair of receptacles 204, each of which is associated with one of OSAs 202 and into which may be plugged a connector (not shown) of a fiber optic cable (not shown). The OSAs 202 and receptacles 204 shown in FIG. 2 are based on the LC optical connector. The OSAs 202 each include a projection 206 that extends into one receptacle 204 and has an optical fiber bore 208 for receiving a ferrule of a fiber optic cable connector that is to be mated therewith. Although OSAs 202 and receptacles 204 shown in FIG. 2 are based on the LC optical connector, the OSAs and receptacles may be based on other types of connectors, such as the MTP optical connector (also known as the type MPO connector), the SC optical connector, or the like.

The OSAs 202 are electrically connected to an electronic circuit board 210 that incorporates circuitry of the type conventionally included in optoelectronic transceiver modules, such as a laser driver, laser control, receiver post-amplifier, signal-detect circuits, and power-on reset circuits. Typically, receptacles 204 are integrally formed as a portion of a plastic retainer 212 that retains OSAs 202 and electronic circuit board 210 in position. Alternatively, receptacles 204 and a retainer member may be formed separately as two or more pieces. A bottom cover 214, a top front cover 216, and a top rear cover 218 form the housing of optoelectronic transceiver module 200. Typically, these cover members are made of metal to provide electromagnetic shielding.

Typically, optoelectronic transceiver module 200 is electrically connected to an electronic circuit board 220 of a computer or I/O device. For example, optoelectronic transceiver module 200 may be connected to electronic circuit board 220 of the computer or I/O device using a fixed connection as shown in FIG. 2, e.g., a pin-through-hole arrangement that connects electronic circuit board 210 of optoelectronic transceiver module 200 to electronic circuit board 220 of the computer or I/O device. Alternatively, optoelectronic transceiver module 200 may be connected to electronic circuit board 220 of the computer or I/O device using a removable connection, e.g., a hot-pluggable contact pad mechanism that connects electronic circuit board 210 of optoelectronic transceiver module 200 to electronic circuit board 220 of the computer or I/O device.

Optoelectronic transceiver module 200 receives optical signals from the fiber optic cable, converts the optical signals to electrical signals, and provides the electrical signals to the electronic circuit board 220 of the computer or I/O device. Likewise, optoelectronic transceiver module 200 receives electrical signals from the electronic circuit board 220 of the computer or I/O device, converts the electrical signals to optical signals, and provides the optical signals to the fiber optic cable. Optoelectronic transceiver module 200 receives optical signals from the fiber optic cable using receiver optical subassembly (ROSA) 202R and provides the optical signals to the fiber optic cable using transmitter optical subassembly (TOSA) 202T.

A ROSA typically includes a lens that receives the optical signals from the fiber optic cable and focuses the optical signals on an optoelectronic device provided with a receiver unit, e.g., a photoelectric receiver chip, that converts the fiber optic signals to electrical signals. Similarly, a TOSA typically includes an optoelectronic device provided with a transmitter unit, e.g., an edge-emitting laser (CD) or a surface-emitting laser (VCSEL), that converts electrical signals to optical signals that are directed onto a lens that directs the optical signals to the fiber optic cable.

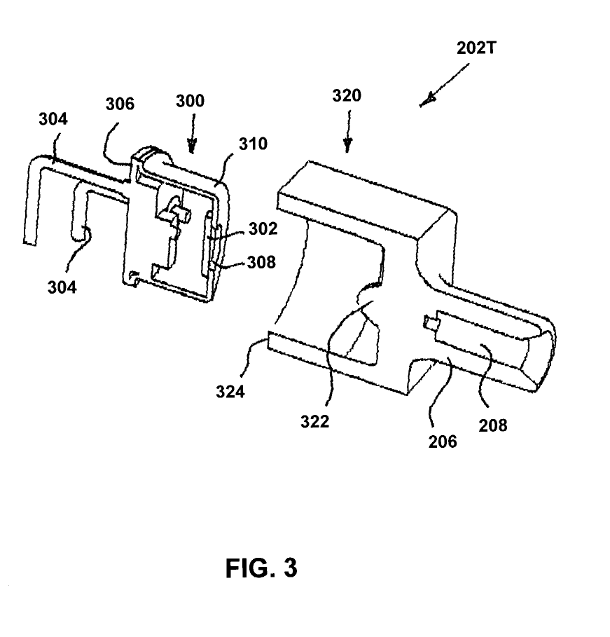

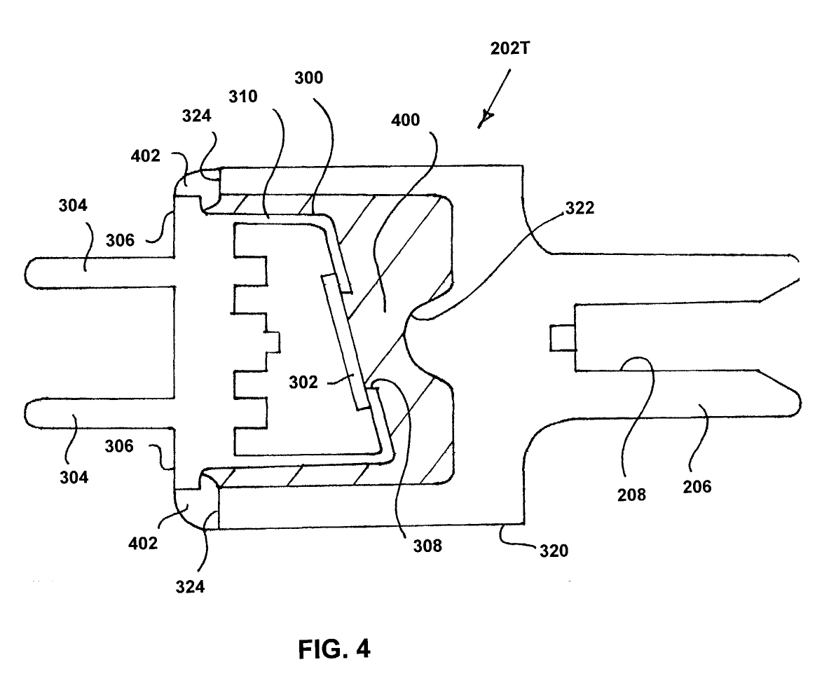

FIG. 3 is an exploded perspective enlarged view of one of the optical subassemblies (OSAs) 202 of the optoelectronic transceiver module shown in FIG. 2. The OSA is shown in FIG. 3 prior to application of a multifunctional acrylate resin adhesive interface according to an embodiment of the present invention shown in FIG. 4. Although only transmitter optical subassembly (TOSA) 202T is shown in FIG. 3, the present invention may also be employed in receiver optical subassembly (ROSA) 202R, which has a similar structure.

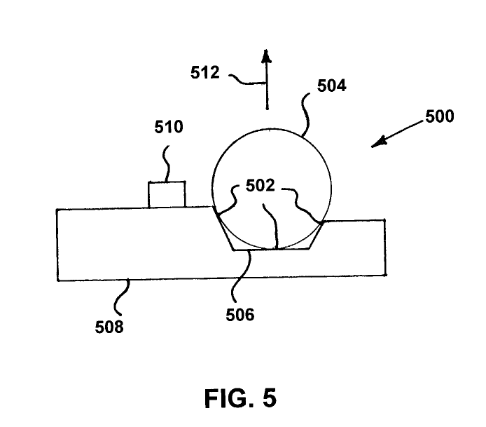

The present invention is not limited to use in the OSA structure shown in FIGS. 3 and 4, and may be used in other types of optical subassemblies. For example, the present invention may be used in an optical subassembly having optical components mounted on an optical bench as discussed in detail below with reference to FIG. 5.

Referring back to FIG. 3, TOSA 202T includes an optoelectronic device 300 provided with a transmitter unit 302, e.g., an edge-emitting laser (CD) or a surface-emitting laser (VCSEL), that converts electrical signals to optical signals that are directed onto a lens 322 that directs the optical signals to the fiber optic cable. Although not shown, ROSA 202R includes a similar optoelectronic device with a receiver unit, e.g., a photoelectric receiver chip, that converts the fiber optic signals to electrical signals. Typically, optoelectronic device 300 is in the form of a transistor-outline (TO) can as shown in FIG. 3, both for TOSAs and ROSAs. TO-cans are advantageous in that they offer a hermetic, high-reliability package. The electrical signals are provided to TOSA 202T through electrodes 304 that exit a deck portion 306 at the rear of the TO-can. The optical signals exit TOSA 202T through a window 308 in a cup-shaped portion 310 at the front of the TO-can.

In the embodiment shown in FIG. 3, TOSA 202T (ROSA 202R) has a housing member 320 that is used to enclose optoelectronic device 300 and a lens 322 and to align lens 322 with respect to the transmitter unit (receiver unit) of optoelectronic device 300. Housing member 320 is preferably injection molded using an optically clear plastic, e.g., Ultem® polyetherimide available from GE Plastics, so that lens 322 and projection 206 may be integrally formed with housing member 320. As discussed above, projection 206 is provided with an optical fiber bore 208 for receiving a ferrule of a fiber optic cable connector that is to be mated therewith. Alternatively, housing member 320, lens 322 and projection 206 may be formed separately as two or more pieces.

Optoelectronic Subassembly with Multifunctional Acrylate Resin Adhesive Interface

FIG. 4 is a cross-sectional view of an optical subassembly (OSA) that includes a multifunctional acrylate resin adhesive interface 400 according to an embodiment of the present invention. Although a transmitter optical subassembly (TOSA) is shown in FIG. 4 for the purpose of illustration, the present invention is also applicable in a receiver optical subassembly (ROSA).

Multifunctional acrylate resin adhesive interface 400 is included between lens 322 and optoelectronic device 300, e.g., having a laser 302 or a photoelectric receiver chip. Multifunctional acrylate resin adhesive interface 400 is formed by curing an adhesive material including a multifunctional acrylate resin and, preferably, a photoinitiator and/or a thermal initiator. Suitable multifunctional acrylate resins include, for example, di-, tri-, tetra-, pentafunctional acrylate resins, or a mixture thereof. Illustrative suitable commercially-available multifunctional acrylate resins include, for example, Sartomer 351 (trimethylolpropane triacrylate), Sartomer 350 (trimethylolpropane trimethaacrylate), Sartomer 444 (pentaerythritol di-, tri-, tetraacrylates), and Sartomer 399 (dipentaerythritol pentaacrylate), each available from the Sartomer Company, Exton, Pa. Additionally, the adhesive material preferably includes a conventional thermal initiator (e.g., organic peroxide) and/or a photoinitiator (e.g., an aromatic ketone) such as Irgacure 184 (1-Hydoxycyclohexyl phenyl ketone) available from Ciba Specialty Chemicals, Inc. As shown in the TABLE below, an adhesive material including a multifunctional acrylate resin cures to form an adhesive having a tightly cross-linked network of low CTE (coefficient of thermal expansion). The low CTE of multifunctional acrylate resin adhesive interface 400 can reduce (as compared to conventional, optically clear adhesives) thermally-induced stress at the bond line at the operating temperature of the subassembly.

In preparing the TABLE below, various multifunctional acrylate resins with 1 wt % Irgacure 184 as photoinitiator were cast into right cylinders (i.e., disks) and UV cured (90 J/cm² dose from a Novacure® UV spot curing source available from EFOS USA Inc., Williamsville, N.Y.). CTE measurements were conducted over a temperature range of 0-100° C. at a scan rate of 5° C./min using a 1 mm quartz probe. For comparison, a conventional unfilled adhesive (Norland NOA61 available from Norland Products Inc., Cranbury, N.J.), a conventional filled adhesive (Optocast 3408 available from Electronics Materials Inc., Breckenridge, Colo.), and a monofunctional acrylate resin (Sartomer 440 available from the Sartomer Company, Exton, Pa.) were prepared and processed in an identical manner.

TABLE

| | | CTE |
|---|---|---|
| | | (ppm/° C.), |
| Resin | Functionality | T < T_{g} |
| Norland NOA61 | Difunctional | 220.0 |
| | (unfilled) | |
| Optocast 3408 | Difunctional | 40.6 |
| | (mineral filled) | |
| Sartomer 351 | Trifunctional | 53.1 |
| (trimethylolpropane triacrylate) | (unfilled) | |
| Sartomer 350 | Trifunctional | 46.1 |
| (trimethylolpropane trimethacrylate) | (unfilled) | |
| Sartomer 444 | Mixed di, tri, | 43.0 |
| (pentaerythritol di-, tri-, tetraacrylates) | tetrafunctional | |
| | (unfilled) | |
| Sartomer 399 | Pentafunctional | 28.4 |
| (dipentaerythritol pentaacrylate) | (unfilled) | |
| Sartomer 440 | Monofunctional | NA |
| (isooctyl acrylate) | (unfilled) | |

Within the multifunctional acrylate resin series, it can be seen that increasing the functionality results in markedly lower CTE. The pentafunctional acrylate resin exhibits a very low CTE of 28.4 ppm/° C. up to 100° C. This is much lower than the unacceptable CTE of Norland NOA61 (which is unfilled and provides the necessary clarity) and is even lower than the acceptable CTE of Optocast 3408 (which is filled to control CTE, but is unacceptably opaque). The isooctyl acrylate resin, being monofunctional, polymerized into a linear polymer with little or no cohesive integrity rendering CTE determination impossible.

Multifunctional acrylate resin adhesive interface 400 preferably contacts substantially the entire interior surface of housing member 320 and substantially the entire exterior surface of the cup-shaped portion 310 of optoelectronic device 300. This increases the surface area available for bonding. The surface shape of lens 322 is selected based on the refractive index of multifunctional acrylate resin adhesive interface 400.

Preferably, the adhesive material is optically clear at the operating wavelength of the optoelectronic device, curable via UV and/or thermal initiation, rapid curing, has excellent adhesion to high surface energy plastics and metals, and has adequate viscosity. With regard to the adhesive material preferably being optically clear at the operating wavelength (e.g., 850 nm) of the optoelectronic device, a transmittance of at least 90% is preferred for an unattenuated OSA. However, transmittance can be tailored via incorporation of an appropriate conventional dye such that the laser power is reduced to acceptable levels. Highly filled adhesive materials will be opaque at the operating wavelength of the optoelectronic device.

With regard to the adhesive material preferably being curable via UV and/or thermal initiation, the adhesive material may have a sluggish cure speed due to absorption of UV radiation by the housing member. In this case, a conventional thermal initiator may be added to the adhesive material to drive the conversion toward completion. With regard to the adhesive material preferably being rapid curing, the OSAs are typically individually aligned (i.e., the laser (or receiver chip) of optoelectronic device is aligned with respect to the lens) and thus throughput is gated by the alignment/cure process. Rapid curing ensures that cycle time will be kept to a minimum.

With regard to the adhesive material preferably having excellent adhesion to high surface energy plastics and metals, the adhesive material will preferably function to better adhere the optoelectronic device to the housing member (as well as being an index-matching material). Thus, the adhesive material will preferably exhibit excellent adhesion to surfaces of the housing member (e.g., Ultem) and surfaces of the optoelectronic device (e.g., gold and/or nickel).

With respect to the adhesive material preferably having adequate viscosity, the adhesive material is preferably dispensed on both the laser (or receiver chip) and the lens surfaces prior to mating the optoelectronic device to the housing member in order to prevent air entrapment at either the laser or the lens surfaces. The viscosity must be high enough to prevent excessive slumping or dripping yet low enough to enable adequate wetting of both surfaces. A suitable range is between 500-100,000 cP.

The adhesive material is applied both to lens 322 (preferably, to substantially the entire interior surface of housing member 320) and window 308 of optoelectronic device 310 (preferably, to substantially the entire exterior surface of the cup-shaped portion 310 of optoelectronic device 300). Next, housing member 320 and optoelectronic device 300 are joined and aligned. Finally, the adhesive material is cured to form multifunctional acrylate resin adhesive interface 400. The adhesive material may be cured by exposure to UV radiation and/or heat, for example. In addition, a conventional structural adhesive 402 may be dispensed in an area between deck portion 306 of the TO-can and a lip portion 324 of housing member 320 and cured to provide additional rigidity and durability to OSA 202.

Optoelectronic Subassembly with Multifunctional Acrylate Resin Adhesive Contact Points

The present invention is not limited to use in the OSA structure shown in FIGS. 3 and 4, and may be used in other types of optical subassemblies. For example, as shown in FIG. 5, the present invention may be used in an optical subassembly having optical components (e.g., a lens, a laser and/or a photoelectric receiver chip) mounted on an optical bench.

FIG. 5 is a side elevational view of an optical subassembly (OSA) 500 that includes multifunctional acrylate resin adhesive contact points 502 according to another embodiment of the present invention. The multifunctional acrylate resin adhesive contact points 502 adhere a ball lens 504 to a recess 506 of an optical bench 508. Preferably, optical bench 508 is silicon and recess 506 is precision machined or etched onto a surface thereof. The optical bench 508 also has an optoelectronic device 510, e.g., a device having a laser or a photoelectric receiver chip, mounted thereon. The optoelectronic device 510 may be adhered to optical bench 508 using conventional techniques or, alternatively, using multifunctional acrylate resin adhesive contact points consistent with the present invention. In addition, optoelectronic device 510 may be soldered or otherwise electrically connected to electrical pads or traces on optical bench 508, if desired, using methods and materials generally known to those skilled in the art. Precision alignment of ball lens 504 to optical bench, and thus to optoelectronic device 510, is essential for proper functioning of subassembly 500, i.e., ball lens 504 is precisely aligned to focus light from a fiber optic cable to a photoelectric receiver chip, or from a laser to a fiber optic cable.

Multifunctional acrylate resin adhesive contact points 502 are formed by curing an adhesive material including a multifunctional acrylate resin and, preferably, a photoinitiator and/or a thermal initiator. Suitable multifunctional acrylate resins include, for example, di-, tri-, tetra-, pentafunctional acrylate resins, or a mixture thereof. Illustrative suitable commercially-available multifunctional acrylate resins include, for example, Sartomer 351 (trimethylolpropane triacrylate), Sartomer 350 (trimethylolpropane trimethaacrylate), Sartomer 444 (pentaerythritol di-, tri-, tetraacrylates), and Sartomer 399 (dipentaerythritol pentaacrylate), each available from the Sartomer Company, Exton, Pa. Additionally, the adhesive material preferably includes a conventional thermal initiator (e.g., organic peroxide) and/or a photoinitiator (e.g., an aromatic ketone) such as Irgacure 184 (1-Hydoxycyclohexyl phenyl ketone) available from Ciba Specialty Chemicals, Inc. As shown in the TABLE set forth above in the discussion of the previous embodiment, an adhesive material including a multifunctional acrylate resin cures to form an adhesive having a tightly cross-linked network of low CTE (coefficient of thermal expansion). The low CTE of multifunctional acrylate resin adhesive contact points 502 can reduce (as compared to conventional, optically clear adhesives) thermally-induced vertical offset (in the direction denoted as arrow 512 in FIG. 5), for example, of ball lens 504 relative to optical bench 508 and optoelectronic device 510 at the operating temperature of subassembly 500.

Alignment of ball lens 504 relative to optical bench 508 and optoelectronic device 510 is typically accomplished at room temperature regardless of the continuous use temperature of subassembly 500. Because the CTE of conventional optically clear adhesives often exceeds 100 ppm/° C., coupled with the fact that subassembly 500 may operate at temperatures approaching 70° C., the conventional adhesive will often expand significantly at operating temperature (as compared to its size when aligned at room temperature). This expansion can result in misalignment of ball lens 504 relative to optoelectronic device 510. The low CTE of multifunctional acrylate resin adhesive contact points 502 solves this problem. Ball lenses bonded to optical benches with multifunctional acrylate resin adhesive contact points (preferably di-, tri-, tetra-, pentafunctional acrylate resins, or a mixture thereof; and more preferably pentafunctional acrylate resins) exhibit essentially no vertical movement thereby ensuring precision alignment of ball lens 504 to the optical bench 508 and optoelectronic device 510.

As mentioned in the discussion of the previous embodiment, the pentafunctional acrylate resin in the TABLE above exhibits a very low CTE of 28.4 ppm/° C. up to 100° C. This is much lower than the unacceptable CTE of Norland NOA61 (which is unfilled and provides the necessary clarity) and is even lower than the acceptable CTE of Optocast 3408 (which is filled to control CTE, but is unacceptably opaque). For precision alignment of ball lens 504 relative to optical bench 508, the adhesive material must be transparent in order to ensure proper dispense volume.

An adhesive material including a multifunctional acrylate resin is applied to ball lens 504 and/or recess 506 of silicon optical bench 508, which are then joined and the adhesive material cured. The adhesive material is preferably cured by exposure to UV radiation and/or heat.

While this invention has been described with respect to the preferred and alternative embodiments, it will be understood by those skilled in the art that various changes in detail may be made therein without departing from the spirit, scope, and teaching of the invention. Accordingly, the herein disclosed invention is to be limited only as specified in the following claims.

What is claimed is:

1. An optical subassembly for an optoelectronic module, comprising:
a lens;
an optoelectronic device;
an adhesive physically contacting and adhering at least one of the lens and the optoelectronic device, wherein the adhesive is formed by at least partially curing an adhesive composition comprising a multifunctional acrylate resin.

2. The optical subassembly as recited in claim 1, wherein optoelectronic device includes a laser.

3. The optical subassembly as recited in claim 1, wherein optoelectronic device includes a photoelectric receiver chip.

4. The optical subassembly as recited in claim 1, wherein the lens is a ball lens.

5. The optical subassembly as recited in claim 4, further comprising an optical bench having a recess, and wherein the adhesive affixes a portion of the ball lens to the recess.

6. The optical subassembly as recited in claim 5, wherein the optical bench includes a raised area adjacent to the recess, and wherein the optoelectronic device is mounted to the raised area.

7. The optical subassembly as recited in claim 6, wherein optoelectronic device includes a laser.

8. The optical subassembly as recited in claim 6, wherein optoelectronic device includes a photoelectric receiver chip.

9. The optical subassembly as recited in claim 1, wherein the multifunctional acrylate resin is selected from a group consisting of difunctional acrylate resins, trifunctional acrylate resins, tetrafunctional acrylate resins, pentafunctional acrylate resins, and mixtures thereof.

10. The optical subassembly as recited in claim 9, wherein multifunctional acrylate resin comprises a pentafunctional acrylate resin.

11. An optoelectronic module, comprising:
a housing;
an electronic circuit board mounted within the housing;
at least one optical subassembly connected to the electronic circuit board, the at least one optical subassembly comprising:
a lens;
an optoelectronic device;
an adhesive physically contacting and adhering at least one of the lens and the optoelectronic device, wherein the adhesive is formed by at least partially curing an adhesive composition comprising a multifunctional acrylate resin.

12. The optoelectronic module as recited in claim 11, wherein the at least one optical subassembly includes a transmitter optical subassembly the optoelectronic device of which includes a laser, and wherein the at least one optical subassembly includes a receiver optical subassembly the optoelectronic device of which includes a photoelectric receiver chip.

13. The optoelectronic module as recited in claim 11, wherein the at least one optical subassembly further comprises an optical bench having a recess and a raised area adjacent to the recess, and wherein the optoelectronic device is mounted to the raised area and the adhesive affixes at least a portion of the lens to the recess.

14. The optoelectronic module as recited in claim 11, wherein the multifunctional acrylate resin is selected from a group consisting of difunctional acrylate resins, trifunctional acrylate resins, tetrafunctional acrylate resins, pentafunctional acrylate resins, and mixtures thereof.

15. A method of making an optical subassembly, comprising the steps of:
providing an adhesive composition comprising a multifunctional acrylate resin;
applying the adhesive composition to at least one of a lens and an optical bench;
joining the lens and the optical bench;
at least partially curing the adhesive composition.

16. The method as recited in claim 15, wherein the optical bench has a recess, and wherein the joining step includes the step of placing a portion of the lens in the recess.

17. The method as recited in claim 16, further comprising the step of mounting an optoelectronic device to the optical bench, wherein the optoelectronic device includes at least one of a laser and a photoelectric receiver chip.

18. The method as recited in claim 17, wherein the optical bench has a raised area adjacent to the recess, and wherein the optoelectronic device is mounted to the raised area.

19. The method as recited in claim 15, wherein the multifunctional acrylate resin is selected from a group consisting of difunctional acrylate resins, trifunctional acrylate resins, tetrafunctional acrylate resins, pentafunctional acrylate resins, and mixtures thereof.

20. The method as recited in claim 15, wherein the curing step includes the step of exposing the adhesive composition to at least one of UV radiation and heat.
